(19) United States
(12) Patent Application Publication
(10) Pub. No.: US 2004/0184778 A1
(43) Pub. Date: Sep. 23, 2004

(54) Information storage medium storing still picture, reproducing apparatus and method therefor

(75) Inventors: Kil-soo Jung, Gyeonggi-do (KR); Seong-jin Moon, Gyeonggi-do (KR); Hyun-kwon Chung, Seoul (KR); Sung-wook Park, Seoul (KR); Jung-kwon Heo, Seoul (KR); Jung-wan Ko, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG Electronics Co., Ltd., Suwon-city (KR)

(21) Appl. No.: 10/717,922

(22) Filed: Nov. 21, 2003

(30) Foreign Application Priority Data
Nov. 21, 2002 (KR) 2002-72839
Nov. 10, 2003 (KR) 2003-79178

(51) Int. Cl. H04N 5/76

(52) U.S. Cl. 386/95; 386/96

(57) ABSTRACT

An information storage medium storing at least one still image data clip including: at least one still image data file; still image clip information including information on a position and attributes of still images in the at least one still image data file; and still image sequence information including information on presentation modes and a presentation time for the still images in the at least one still image data file.

### CROSS-REFERENCE TO RELATED APPLICATIONS

This application claims the priority of Korean Patent Application Nos. 2002-72839 and 2003-79178, respectively filed on Nov. 21, 2002 and Nov. 10, 2003, in the Korean Intellectual Property Office, the disclosures of which are incorporated herein in their entireties by reference.

### BACKGROUND OF THE INVENTION

1. Field of the Invention

The present invention relates to the structure of a still picture, and more particularly, to an information storage medium storing a still picture, a reproducing apparatus and a method therefor.

2. Description of the Related Art

The adoption and/or use of multi-media files such as, for example, image, audio, and video files is ever increasing. The need to store such files is also increasing. However, the structure of an information storage medium to store widely applicable still image data is not provided.

### SUMMARY OF THE INVENTION

The present invention provides an information storage medium storing a still picture with a widely applicable structure, and a reproducing apparatus and a method therefor.

Additional aspects and/or advantages of the invention will be set forth in part in the description which follows and, in part, will be obvious from the description, or may be learned by practice of the invention.

According to an aspect of the present invention, there is provided an information storage medium storing at least one still image data clip including: at least one still image data file; still image clip information including information on a position and attributes of still images in the at least one still image data file; and still image sequence information including information on presentation modes and a presentation time for the still images in the at least one still image data file.

According to another aspect of the present invention, there is provided a reproducing apparatus for performing reproduction from an information storage medium storing still image data as clips, including: a system clock counter which generates a system clock increasing at each point in time; a reader which reads information on a presentation time for each of at least one still image data file, from the information storage medium, the information storage medium including a still image data clip including the at least one still image data file and information on a presentation mode and the presentation time for the at least one still image data file, and then reads still image data which is to be presented within a presentation time correspond s to the system clock; a video decoder which, when the system clock has a value within a range of the presentation time for the still image data, decodes the still image data; and a data output unit which outputs the decoded still image data.

According to still another aspect of the present invention, there is provided a method of performing reproduction from an information storage medium storing still image data as clips using a reproducing apparatus generating a system clock increasing at each point in time, the method including: reading information on a presentation time for at least one still image data file, from the information storage medium, the information storage medium including a still image data clip including the at least one still image data file and information on a presentation mode and the presentation time for the at least one still image data file, and then reading still image data which is to be presented within a presentation time corresponds to the system clock; decoding the still image data when the system clock has a value within a range of the presentation time for the still image data; and outputting the decoded still image data.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a coding system according to MPEG standards;

FIG. 2 is a view for explaining a method of reproducing packet data to which arrival time information is added;

FIG. 3 is a block diagram of a reproducing apparatus to reproduce packet data to which arrival time information is added;

FIG. 4 is a view showing the relationship among a playlist, a playitem, and a clip;

FIG. 5 is a detailed view of the new playlist of FIG. 4;

FIG. 6 is a view showing the structure of a clip information file used for a still picture, according to an embodiment of the present invention;

FIG. 7 is a view showing the structure of clip info when a still picture clip includes a plurality of still image files, each of which includes one still image data;

FIG. 8 is a view showing the structure of clip info when a still picture clip includes a still image file which includes a plurality of still image data;

FIG. 9 is a view showing the structure of sequence info when a presentation mode is a slide show;

FIG. 10 is a view showing the structure of sequence info when a presentation mode is a browsable slide show;

FIG. 11 is a view showing a slide show to present a still picture, according to an embodiment of the present invention;

FIG. 12 is a view showing a browsable slide show to present a still picture, according to an embodiment of the present invention; and

FIG. 13 is a block diagram of a reproducing apparatus according to another embodiment of the present invention.

### DETAILED DESCRIPTION OF THE EMBODIMENTS

Reference will now be made in detail to embodiments of the present invention, examples of which are illustrated in the accompanying drawings, wherein like reference numerals refer to the like elements throughout. The embodiments are described below to explain the present invention by referring to the figures.

FIG. 1 is a block diagram of a coding system according to MPEG standards. Referring to FIG. 1, the coding system includes a video coder 100, an audio coder 110, a video packetizer 120, an audio packetizer 130, a program stream multiplexer 140, and a transport stream multiplexer 150. The video coder 100 and the audio coder 110 code video data and audio data, respectively. The video packetizer 120 and the audio packetizer 130 respectively transform the coded video data and the coded audio data into respective video packetized elementary stream (PES) packet and an audio PES. Here, the PES packets are made by dividing coded data according to a size. The program stream multiplexer 140 may multiplex the video and audio PES packets in a program stream or the transport stream multiplexer 150 may multiplex the video and audio PES packets in a transport stream.

The program stream is used in an information storage medium and multiplexed in a program stream (PS) pack unit. By way of a non-limiting example, a representative moving picture storage medium uses 2048-byte PS packs according to DVD video standards.

The transport stream is usable in an application in which data is lost as in digital broadcasting, and multiplexed in a transport stream (TS) pack unit. The size of one TS pack may be 188 bytes.

In general, an application to store digital broadcasting data on an information storage medium uses the TS. In the present embodiment, the TS is used. However, the present embodiment is also applicable to a case where the PS is used.

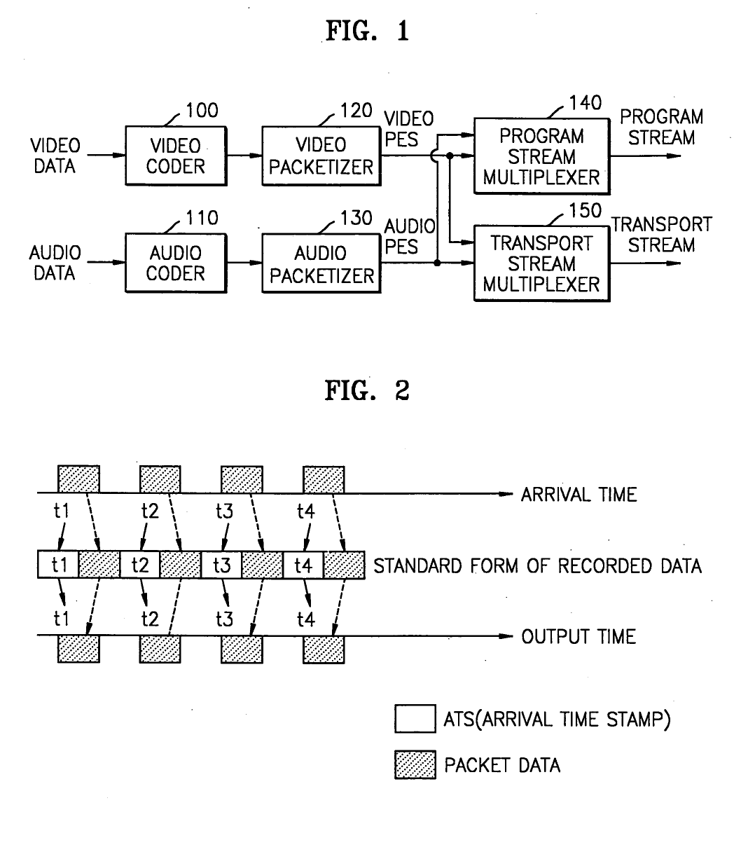

FIG. 2 is a view for explaining a method of reproducing packet data to which arrival time stamps (ATSs) are added. Referring to FIG. 2, a receiver receives packet data from a transmitter at specific time intervals. In order to measure such time intervals, the receiver includes a counter which is driven by a system clock with a frequency of, by way of a non-limiting example, 90 kHz or 27 MHz. Thus, while a frequency of 90 kHz or 27 MHz is discussed, it is to be understood that other frequencies are possible. The receiver adds arrival times t1, t2, in front of packet data and records the packet data with the arrival times t1, t2, . . . on the information storage medium. The arrival times t1, t2, . . . are called arrival time stamps (ATSs). The receiver reproduces the packet data at the same time intervals as the specific time intervals based on time intervals determined by recorded ATS values. The time intervals between packet data are not constant (i.e., not uniform) when transmitting digital broadcasting data. The transmitted packet data is generally stored in a buffer of a receiver including a decoder and decoded by the decoder so that a user can view broadcasting. In other words, packet data is temporally stored in the buffer, and then the reproducing apparatus transmits the packet data to the decoder when the user desires to view broadcasting. Here, time intervals at which original packet data is transmitted are important. The transmitter adjusts the time intervals in consideration of the status of the buffer of the receiver and then transmits the packet data. Thus, when the transmitter fails to adjust the time intervals, the buffer of the receiver overflows or underflows with packet data. For compatability, ATSs are usable in the present embodiment.

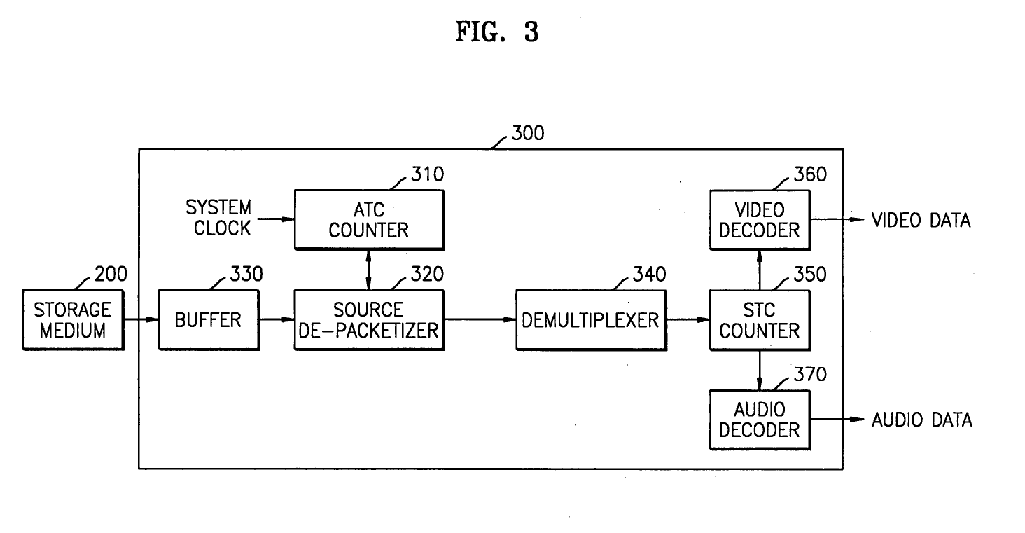

FIG. 3 is a block diagram of a reproducing apparatus to reproduce packet data to which arrival time information is added. Referring to FIG. 3, a reproducing apparatus 300 includes an arrival time clock (ATC) counter 310, a source de packetizer 320, a buffer 330, a demultiplexer 340, a system time clock (STC) counter 350, a video decoder 360, and an audio decoder 370.

The buffer 330 reads a source data packet from a storage medium 200 and temporally stores the data packet. The source de-packetizer 320 depacketizes an MPEG2-TS transport packet from a source data packet. However, while an MPEG2-TS transport packet is discussed, it is to be understood that other packets are possible. The ATC counter 310 is driven by a system clock with a frequency of 90 kHz or 27 MHz. When the source de-packetizer 320 receives a first packet of a TS, the ATC counter 310 resets an ATS to an initial value and continuously increases a system clock. The source de-packetizer 320 searches for a packet with an ATS value corresponding to the system clock. When the source de-packetizer 320 finds a packet with an ATS value corresponding to the system clock, the source de-packetizer 320 removes the ATS value from the packet and then transmits the packet to the demultiplexer 340. The TS packet transmitted to the demultiplexer 340 includes a program identification (PID) value to indicate a PES packet contained in the TS packet. Thus, when TS packets having the same PID value are collected, original PES packets are restorable.

The TS may further include coding time information called “a program clock reference (PCR)”. The PCR indicates the time when a corresponding packet is input to a decoder buffer. The PCR can contribute to synchronizing the coding time for the coder with the decoding time for the decoder.

The reproducing apparatus 300 controls the STC counter 350 driven by a frequency of 90 kHz or 27 MHz so that a data packet is transmitted to the demultiplex er 340 when a PCR value of the data packet is equal to an STC value. The demultiplexer 340 divides a multiplexed data packet into a video packet and an audio packet, and, when decoding time stamp (DTS) values of the video and audio packets are equal to the STC value, transmits the video packet and the audio packet to the video decoder 360 and the audio decoder 370, respectively. The video decoder 360 and the audio decoder 370 decode the video packet and the audio packet, respectively, and when presentation time stamp (PTS) values of the video packet and the audio packet are equal to the STC value, outputs the decoded video data and the decoded audio data, respectively. Audio data is synchronized with video data by this mechanism.

The above-described reproducing apparatus 300 has a structure suitable for reproducing a moving picture. However, the reproducing apparatus 300 is also suitable to present a still picture in various modes such as a slide show, a browsable slide show, a slide show with audio, a browsable slide show with audio, and so forth.

Such a still picture includes still image streams recorded in consecutive sectors, clip information files including information on attributes of the still image streams, playitems used for still images, a playlist with one or more playitems, an audio stream with audio data, and a sub playitem used for audio.

A moving picture data stream, a still picture data stream, and an audio data stream are recorded in a clip unit on the information storage medium. In general, clips are recorded in consecutive areas of the information storage medium.

Since the moving picture data stream is compressed to reduce its size, information on the characteristics of the moving picture data stream is necessary to reproduce the compressed moving picture data stream. Thus, each of the clips includes additional clip information. The clip information includes audio and video attributes of each clip, information on positions of entry points, and so on. The entry point exists in each predetermined section of a clip so as to have a random access to the clip. Data on the position of the entry point is called an “entry point map.” The entry point map is used for a time search in which the reproducing apparatus searches for a point in time which has elapsed from when the compressed moving picture data stream is reproduced. In a case of MPEG which is used as moving picture compressing techniques, an entry point indicates the position of an I picture including a compressed intra picture.

The still picture data stream is also compressed to reduce its size. Thus, information on the characteristics of the compressed still picture data stream is necessary to reproduce the compressed still picture data stream. For this purpose, each clip includes clip information. JPEG is mainly used as still picture compressing techniques. Since each still picture is intra-compressed, each still picture serves as the I picture of MPEG.

The audio data is also compressed to reduce its size. In a case of a CD-RW, the audio data is compressed using MPEG-1 or Dolby AC-3 protocols, which are widely used compression techniques. A clip information file used for the audio data includes compression information of the corresponding audio file, a file name of audio data included in a clip, information on the positions and attributes of the audio data, and sequence information including information on presentation start and end times for the audio clip.

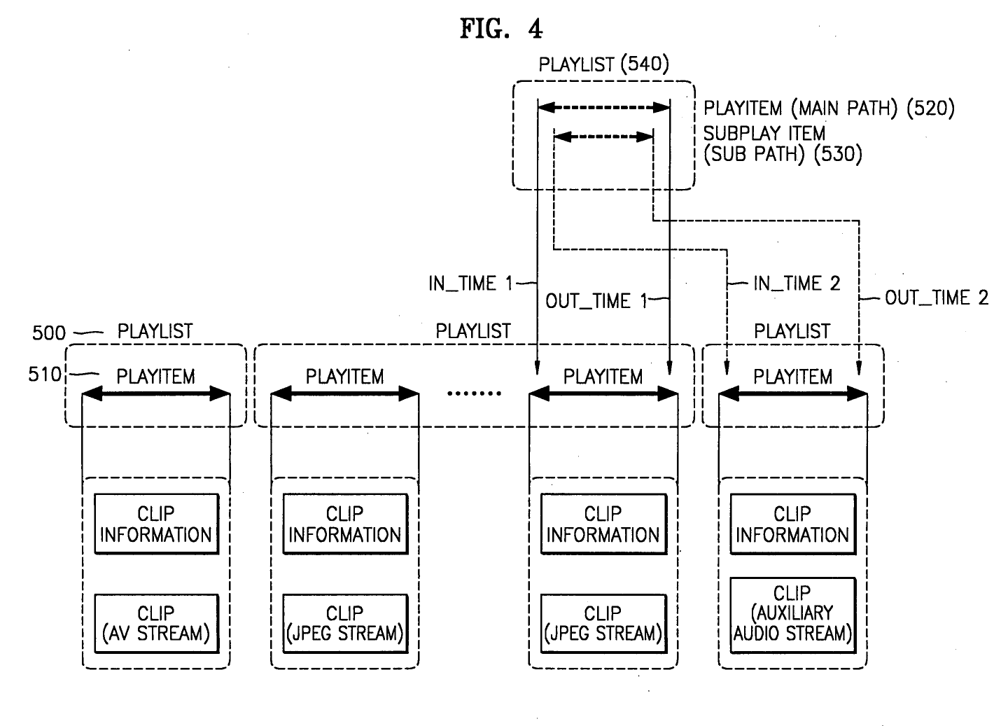

FIG. 4 is a view showing the correlation among a playlist, a playitem, and a clip. Referring to FIG. 4, a playlist 500 is a basic unit for reproduction. The information storage medium stores a plurality of playlists. One playlist includes a plurality of playitems 510. Each of the playitems corresponds to a portion of a clip. In detail, the playitems include the information on presentation start and end times to clips. Thus, clip information can indicate portions of clips corresponding to the playitems. Also, when audio is added as dubbing of audio or as background music during reproduction of a still picture, a portion of a playlist to reproduce a moving picture or a still picture may be selected as a main playitem 520, i.e., a main path, and a portion of a playlist to reproduce an audio stream may be selected as a sub playitem 530, i.e., a sub path. As a result, a new playlist 540 may be created.

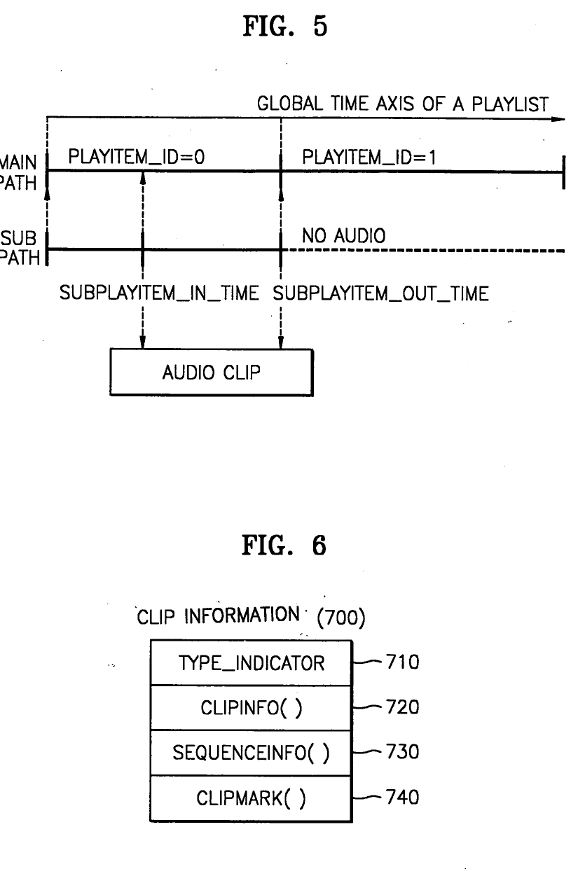

FIG. 5 is a detailed view of the new playlist 540 of FIG. 4. Referring to FIG. 5, playitems of a playlist can be arranged along the global time axis of the playlist. Here, playitem and playitem 1 are arranged in the main path, and one sub playitem is arranged in the sub path. The sub playitem to reproduce audio is presented within a presentation time for one main playitem. In a case where the sub playitem is presented over two or more main playitems, the presentation of the sub playitem may not guarantee the seamlessness. The presentation start time for the sub playitem is in the middle of the presentation duration time of the main playitem 0, and the presentation end time for the sub playitem is equal to the presentation end time for the main playitem 0. Accordingly, since a current main playitem is not changed into another main playitem during the presentation of the sub playitem, the presentation of the sub playitem guarantees the seamless presentation.

FIG. 6 is a view showing the structure of a clip information file used for a still picture, according to an embodiment of the present invention. Referring to FIG. 6, a clip information file 700 includes objects such as a type indicator 710, clip info 720, sequence information 730, and a clip mark 740.

The type indicator 710 includes a value coded by ISO 646. In the present embodiment, the type indicator 710 includes a “JPGS” value to indicate that a still picture clip corresponding to the clip information file 700 is stored in the JPEG form.

The clip information 720 indicates a position and an attribute of each still picture in a clip.

The sequence information 730 includes information on a presentation mode and presentation start and end times for each still image.

The clip mark 740 stores mark information of a corresponding clip.

In view of a file system, a clip with a still image stream may include one file having a plurality of still images or may include a plurality of files each having one still image.

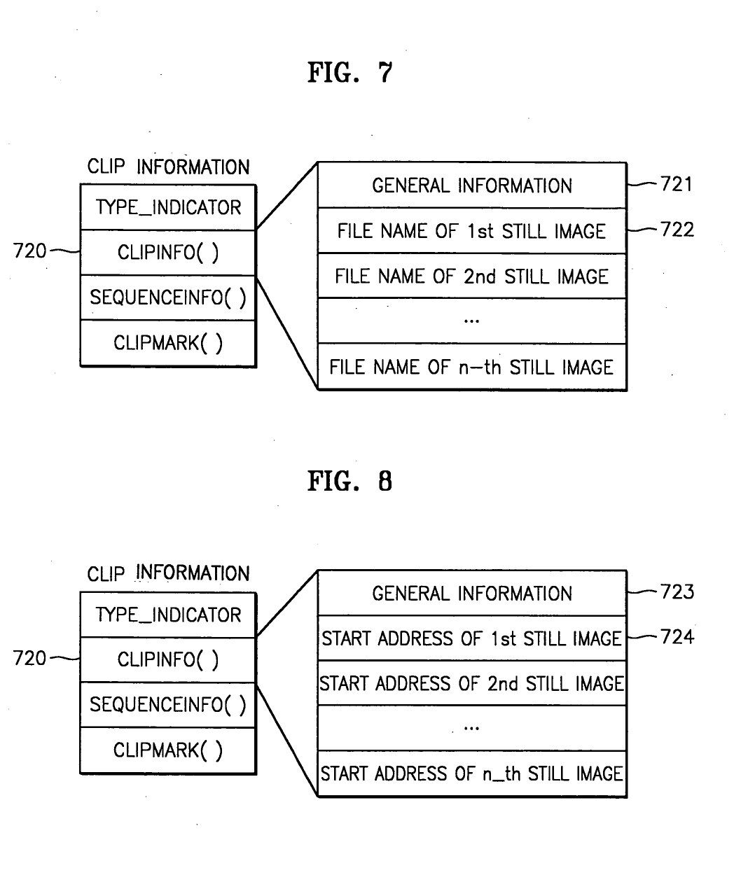

FIG. 7 is a view showing the structure of clip information 720 when a still image clip includes a plurality of files each having one still image. Information on attributes such as a total of bytes of clip information objects, an encoding method for a still picture stream in a still picture clip, and the like is recorded in general information 721 of the clip information 720. The clip information 720 stores file names 722 to indicate positions of still images.

FIG. 8 is a view showing the structure of clip information 720 when a still image clip includes one still image file having a plurality of still images. General information 723 includes information on attributes such as a total of bytes of clip information objects, an encoding method for a still picture stream in a still picture clip, and the like. The clip information 720 stores start addresses 724 of still images to indicate positions of the still images.

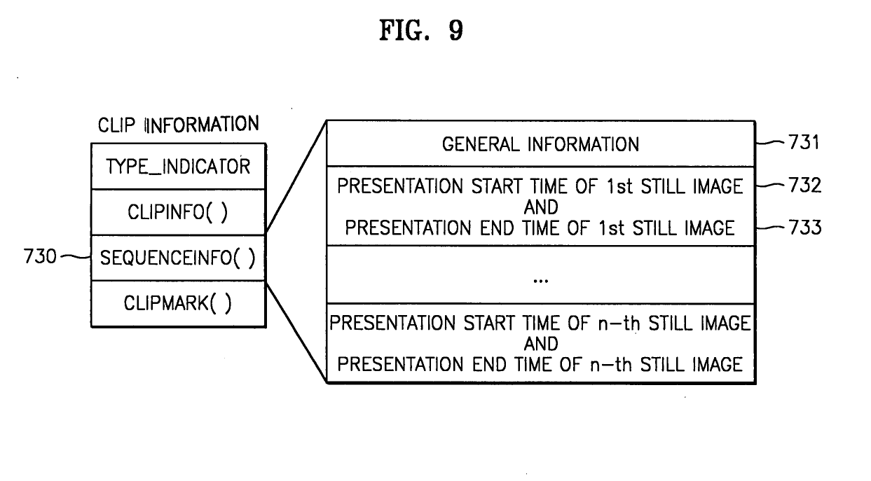

FIG. 9 is a view showing the structure of the sequence information 730 when a presentation mode is a slide show mode. Here, general information 731 of the sequence information 730 stores information on a presentation mode of a corresponding still image stream and a virtual STC to be applied to still images. When a presentation mode is a slide show mode, the sequence information 730 also includes a table of presentation start time 732 and presentation end time 733 for each still image. Here, the presentation start time and the presentation end time are recorded by presentation time stamps (PTSs) according to MPEG standards.

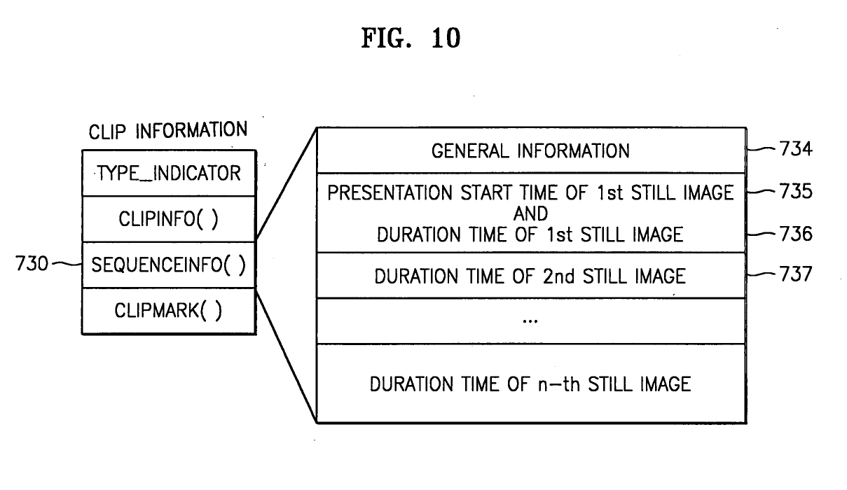

FIG. 10 is a view showing the structure of the sequence information 730 when a presentation mode is a browsable slide show mode. In the browsable slide show mode, a presentation start time 735 is stored only for a first still image, and duration times 736 and 737 are stored for the other still images. The first still image starts its presentation at the presentation start time 735, and the other still images continue their presentations during the duration times 736 and 737. In a case where duration time is set to a finite value, a next still image is presented in a sub mode after the duration time has elapsed. Here, when the sub mode is a sequential mode, a still image in a next position in clip information is presented. When the sub mode is a random or shuffle mode, a still image in a random position is presented. When the duration time is set to an infinite value, a user's input is waited instead of presenting a next still image. When the user's input is executed, a current still image is changed into another still image.

As shown in FIGS. 9 and 10, when a presentation mode is a slide show mode, each still image has a PTS which defines presentation start and end times. When the presentation mode is a browsable slide show mode, each still image has a PTS which defines only presentation start time. In other words, when presentation duration time is set to a finite value, the presentation end time for each still image is set to a value obtained by adding the finite presentation duration time to the presentation start time for each still image. When the presentation duration time is set to an infinite value, the presentation end time for each still image is not set and a current still image is changed into another still image according to a user's scene change command. The still picture forms one virtual STC sequence in the browsable slide show mode.

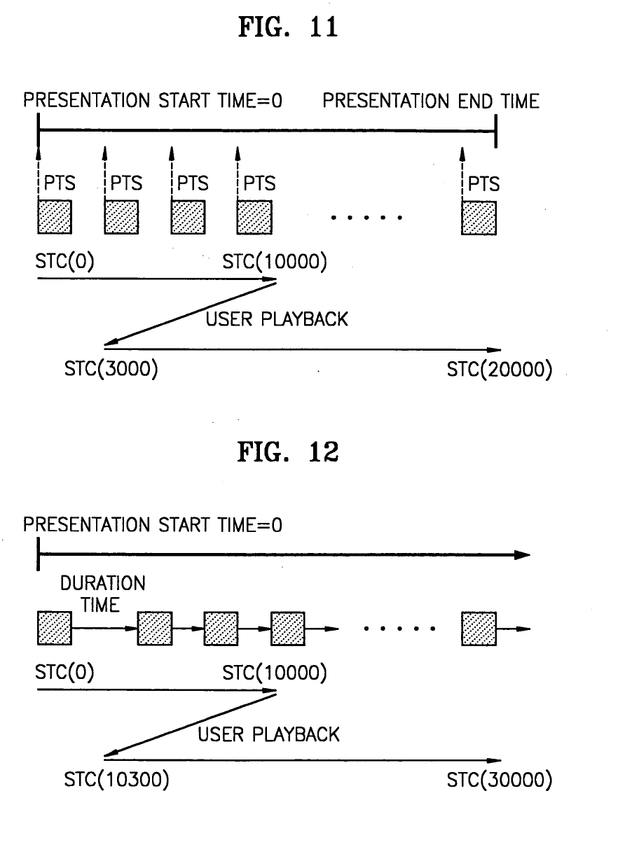

FIG. 11 is a view showing a slide show for a still image, according to an embodiment of the present invention. Referring to FIG. 11, when a playitem for a first still image starts its presentation, an STC is set to 0. Each still image is presented for a presentation time determined from a presentation start time and a presentation end time included in sequence information. Audio data of a sub playitem must be presented within the presentation time for the still image. In a case of a slide show, a time for presenting each still image is determined. Thus, each still image may be played in synchronization with the audio data. In other words, when a user inputs a still image change command such as Fast Forward or Fast Reverse, the STC is changed into a PTS value of a corresponding still image. As can be seen in FIG. 11, when the user inputs a playback command, the STC decreases from 10000 to 3000, and the audio data and still image data has the same STC value.

FIG. 12 is a view showing a browsable slide show for a still image, according to an embodiment of the present invention. Referring to FIG. 12, a sequential presentation, or a random or shuffle presentation according to a user command is available in a browsable slide show mode. A playitem starts its presentation at an STC of 0. However, unlike in the slide show mode, the STC value continuously increases. When a user inputs a playback command, the STC value does not decrease. Thus, audio data with a PTS value corresponding to the increasing STC value is presented. However, since a still image designated by a user's command is presented, the audio data does not synchronize with the designated still image.

In a case where a still picture clip is to be presented for a finite duration time, a still image in a next position (in a sequential mode) or in a random position (in a random or shuffle mode) is presented after the duration time has elapsed with an increase in the STC value.

When the duration time is set to an infinite value, although the STC value increases, one still image continues its presentation until a user command is input.

As described above, although the user command is input, the STC value increases. Thus, this is called a “virtual STC”. When audio data is presented using the virtual STC in a browsable slide show mode, the seamless presentation of the audio data is possible.

In general, the size of a still picture clip is not limited. However, the maximum size of the still picture clip may be limited to the size of a buffer of the reproducing apparatus to guarantee the seamless presentation of audio in a browsable slide show mode.

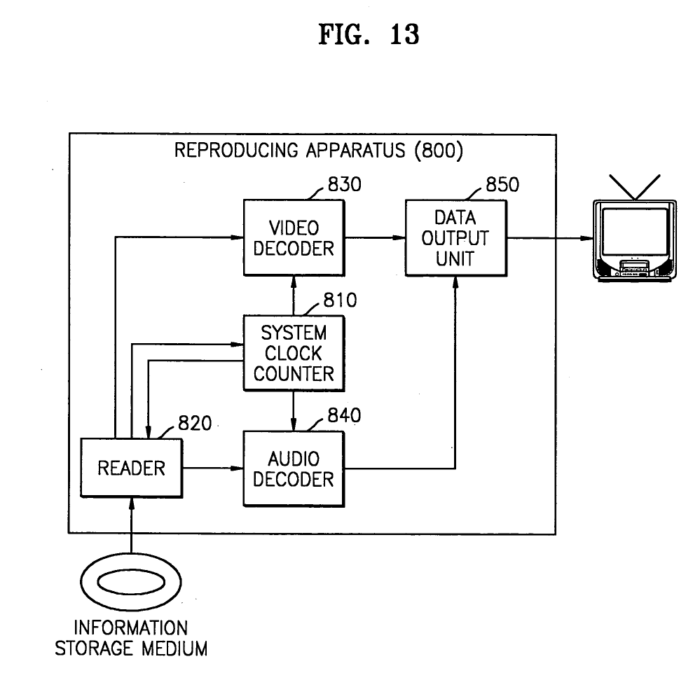

FIG. 13 is a block diagram of a reproducing apparatus, according to another embodiment of the present invention. Referring to FIG. 13, a reproducing apparatus 800 includes a system clock counter 810, a reader 820, a video decoder 830, an audio decoder 840, and a data output unit 850.

The system clock counter 810 generates a system clock increasing at each point in time. It is preferable that the STC is a PTS according to MPEG standards.

The reader 820 reads still image data and audio data from an information storage medium. The system clock counter 810 transmits the system clock to the reader 820 so that the reader 820 reads a data stream which is to presented within a presentation time corresponding to the system clock.

The reader 820 transmits the still image data and the audio data to the video decoder 830 and the audio decoder 840, respectively. When the still image data is to be presented within a presentation time corresponding to the system clock, the video decoder 830 decodes the still image data. When the audio data is to be presented within the presentation time, the audio decoder 840 decodes the audio data.

The data output unit 850 outputs the decoded still image data together with the decoded audio data.

As described above, in an information storage medium and a reproducing apparatus and method therefor, still picture data is presentable in two modes. Also, information necessary for presenting the still picture data is storable. As a result, the still picture data is presentable along with the audio data in a slide show mode by using the information. The seamless reproduction of the audio data is also achievable in a browsable slide show mode.

Although a few embodiments of the present invention have been shown and described, the present invention is not limited to the above-described embodiments. Rather, it would be appreciated by those skilled in the art that changes may be made in this embodiment without departing from the principles and spirit of the invention, the scope of which is defined by the claims and their equivalents.

What is claimed is:

1. An information storage medium storing at least one still image data clip comprising:
at least one still image data file;
still image clip information including information on a position and attributes of still images in the at least one still image data file; and
still image sequence information including information on presentation modes and a presentation time for the still images in the at least one still image data file.

2. The information storage medium of claim 1, wherein the at least one still image data clip includes one still image data file having a plurality of still images, and the information on positions of the plurality of still images are start addresses of the plurality of still images.

3. The information storage medium of claim 1, wherein the at least one still image data clip includes a plurality of still image data files each having one still image, and the information on positions of the still images are file names of the still images.

4. The information storage medium of claim 1, further comprising at least one still image playlist including at least one still image playitem corresponding to a portion of the still image data clip.

5. The information storage medium of claim 4, wherein the at least one still image playitem includes information on a start position and an end position of the portion of the still image data clip.

6. The information storage medium of claim 1, wherein the information storage medium also stores at least one audio data clip including:
at least one audio data file;
audio clip information including information on a position and attributes of the at least one audio data file; and
audio sequence information including information on a presentation time for the at least one audio data file.

7. The information storage medium of claim 6, wherein the presentation time for each of the at least one audio data file is determined using a presentation time stamp according to MPEG standards.

8. The information storage medium of claim 6, wherein the presentation time for each of the at least one audio data file is determined by designating a presentation start time and a presentation end time for the at least one audio data file.

9. The information storage medium of claim 6, further comprising at least one audio data playlist including at least one audio data playitem corresponding to a portion of the audio data clip.

10. The information storage medium of claim 9, wherein the at least one audio data playitem includes information on a start position and an end position of the portion of the audio data clip.

11. The information storage medium of claim 6, wherein a presentation mode for the at least one still image data file is one of a slide show mode in which the presentation time for the at least one still image data file is synchronized with the presentation time for a corresponding audio data file and a browsable slide show mode in which the presentation time for the at least one still image data file is not synchronized with the presentation time for a corresponding audio data file and a presentation order of the at least one still image data file is changeable when the at least one still image data file is presented.

12. The information storage medium of claim 11, wherein the presentation mode is a slide show mode, and the information on the presentation times for the still images of the at least one still image data file are presentation start times and presentation end times for the still images.

13. The information storage medium of claim 12, wherein the presentation start times and the presentation end times for the still images are recorded using a presentation time stamp according to MPEG standards.

14. The information storage medium of claim 11, wherein the presentation mode is a browsable slide show mode, and the information on the presentation times for the still images of the at least one still image data file are a presentation start time for a first still image and presentation and duration times the still images.

15. The information storage medium of claim 11, wherein the presentation mode for the at least one still image data file is the browsable slide show mode, and the total size of still image clips presented within the presentation times for the audio data clips is one of equal to and less than a threshold size.

16. The information storage medium of claim 15, wherein the threshold size is determined according to the size of a data buffer of a reproducing apparatus.

17. A reproducing apparatus for performing reproduction from an information storage medium storing still image data as clips, comprising:
a system clock counter which generates a system clock increasing at each point in time;
a reader which reads information on a presentation time for each of at least one still image data file, from the information storage medium, the information storage medium including a still image data clip including the at least one still image data file and information on a presentation mode and the presentation time for the at least one still image data file, and then reads still image data which is to be presented within a presentation time correspond s to the system clock;
a video decoder which, when the system clock has a value within a range of the presentation time for the still image data, decodes the still image data; and
a data output unit which outputs the decoded still image data.

18. The reproducing apparatus of claim 17, wherein when a user inputs one of a Fast Forward command and a Fast Reverse command during presentation of the still image data in a slide show mode, the system clock counter respectively one of decreases and increases the system clock so as to correspond to the presentation time for the still image data.

19. The reproducing apparatus of claim 17, further comprising an audio decoder which, when the system clock has a value within a range of the presentation time for audio data, decodes the audio data,
wherein the information storage medium has stored thereon the audio data as clips,
wherein the reader reads a presentation time for at least one audio data file from the information storage medium, the information storage medium including an audio data clip including the at least one audio data file and information on a presentation time for the at least one audio data file, and further reads audio data which is to be presented within a presentation time corresponding to the system clock, and
wherein the data output unit outputs the decoded audio data together with the decoded still image data.

20. A method of performing reproduction from an information storage medium storing still image data as clips using a reproducing apparatus generating a system clock increasing at each point in time, the method comprising:
reading information on a presentation time for at least one still image data file, from the information storage medium, the information storage medium including a still image data clip including the at least one still image data file and information on a presentation mode and the presentation time for the at least one still image data file, and then reading still image data which is to be presented within a presentation time corresponding to the system clock;
decoding the still image data when the system clock has a value within a range of the presentation time for the still image data; and
outputting the decoded still image data.

21. The method of claim 20, further comprising one of decreasing and increasing the system clock so as to correspond to the presentation time for the still image data when a user respectively inputs one of a Fast Forward command or a Fast Reverse command during presentation of the still image data in a slide show mode.

22. The method of claim 20, further comprising:
reading a presentation time for at least one audio data file from the information storage medium, the information storage medium including an audio data clip including the at least one audio data file and information on a presentation time for the at least one audio data file, and further reading audio data which is to be presented within a presentation time corresponding to the system clock; and
decoding the audio data when the system clock has a value within a range of the presentation time for the audio data,
wherein in the outputting of the decoded still image data, the decoded audio data is output together with the decoded still image data.
